(19) United States
(12) Patent Application Publication
(10) Pub. No.: US 2021/0389223 A1
(43) Pub. Date: Dec. 16, 2021

(54) METHOD FOR ANALYZING A PARTICLE ACCUMULATION ON A MEMBRANE, DEVICE FOR AUTOMATED ANALYSIS, AND SAMPLE-PREPARATION UNIT THEREFOR

(71) Applicant: JOMESA Meßsysteme GmbH, Ismaning (DE)

(72) Inventors: Konrad STEIGER, Ismaning (DE); Jörn LEPELMEIER, Ismaning (DE); Johann METZGER, Ismaning (DE)

(21) Appl. No.: 17/343,037

(22) Filed: Jun. 9, 2021

(30) Foreign Application Priority Data
Jun. 10, 2020 (DE) 10 2020 115 491.7

(51) Int. Cl. G01N 15/06; G01N 35/00; G02B 21/06; G02B 21/26

(52) U.S. Cl. CPC G01N 15/0618; G01N 35/00; G01N 2035/00475; G02B 21/26; G02B 21/06

(57) ABSTRACT

A method for parallel determination of contrasting particles on a membrane when analyzing an accumulation of particles on the same membrane using an optical microscope is provided. The method involves increasing the transparency of the membrane to light radiation before analyzing particle accumulation.

### TECHNICAL FIELD

The present invention relates to a method for analyzing an accumulation of particles on a membrane using an optical microscope.

The present invention also relates to a device for analyzing an accumulation of particles on a membrane in an automated manner, comprising:
(a) a sample-preparation unit for preparing the particle accumulation in an automated manner, and
(b) an optics unit comprising an optical microscope for analyzing the particle accumulation in an automated manner.

The present invention also relates to a sample-preparation unit for a device for analyzing an accumulation of particles on a membrane in an automated manner, wherein the sample-preparation unit is configured for preparing the particle accumulation on the membrane in an automated manner.

The method according to the invention, the device according to the invention and the sample-preparation unit can be used in automated particle counting, measurement, and categorization, in particular for categorization according to metallic sheen and/or shape. They are suitable both for determining the technical cleanliness in accordance with VDA volume 19.1 and ISO 16232:2018 and for determining particulate contamination in accordance with VDI 2083.

Within the meaning of the invention, the term “membrane” is to be understood to be a broader term for a carrier, on the surface of which a particle accumulation can be deposited; it comprises filter membranes in particular, but also adhesive carrier layers, such as those used in sediment traps.

### PRIOR ART

Determining the technical cleanliness of products or components, but also of rooms or manufacturing processes as part of particle monitoring, is one of the standard quality-assurance tools in many industry sectors. Optical microscopes are often used here, usually in the form of fully automated particle counting microscopes. The advantage of microscopically determining technical cleanliness is that, in addition to particle counting, it is also possible to measure and categorize the particles at the same time. A differentiation can be made between metal and non-metal particles and/or the shape of the particles can be used as a distinguishing criterion.

There are standards for determining technical cleanliness. These are set out in particular for the automotive industry in VDA volume 19.1 and ISO 16232:2018, and in the medical sector are set out by VDI 2083, for example. All the methods described in these sets of rules are based on detecting dark particles on a light background by means of threshold determination.

Direct determination of technical cleanliness is only possible in very few cases, for example on a surface of the product or component to be inspected. The technical cleanliness is therefore usually determined indirectly.

For products or components, the particle analysis in indirect determination usually precedes cleaning the particulate contamination off the surface to be inspected. The particles that have been cleaned off are then deposited on a filter membrane and are subsequently inspected using a microscope. Cellulose membrane filters or mesh filters made of PET or polyamide are usually used for this purpose. Under the microscope, these produce a light, usually white, background, which is particularly suitable for detecting dark particles. Since a flushing liquid is used for the cleaning, this process is often also referred to as extraction.

In order to indirectly determine the technical cleanliness of rooms or manufacturing processes, sediment traps are usually used, which bind sedimented particles to an adhesive layer. The sediment traps are opened during deployment and are closed again after a specified period of time. The particles bound to the adhesive layer during the deployment period are analyzed using a light microscope, usually using an automated particle counting microscope. The adhesive layer is generally positioned on a light, usually white, background.

US 2007/0146870 A1 discloses a particle-analysis system and a particle-analysis method, in which the particles adhering to a surface of the component to be analyzed are removed using a cleaning solution and are then analyzed in the filter residue of the cleaning solution for their size, distribution and chemical nature (metal/non-metal).

The particle accumulations to be analyzed often do not only contain dark particles. In many manufacturing processes, light or transparent particles can also accumulate in addition to dark particles. Light particles include plastics or ceramic particles, for example; transparent particles include glass particles in particular. It is difficult to completely detect these particles against a light background using an optical microscope.

Although there are also filters of different colors, for example grey, black or yellow filters, which could make it possible to detect light particles, all of these filters result in the same problems as light (white) filters, since transparent particles and particles that are the same color as the filter can hardly be detected at all. They always have the drawback that not all types of particle can be detected on a filter.

DE 10 2018 207 535 A1 discloses a method for indirectly analyzing the technical cleanliness of an automotive part using a particle counting microscope, in which the particles deposited on a filter medium are fixed using an adhesive agent before the particles deposited on the filter medium are analyzed using a microscope. In order to increase the reliability of the analysis, the analysis is carried out using two light sources, one of which generates visible light and the other generates UV light. Although the use of two light sources may increase the reliability of the analysis, it does not ensure that all the particles can be detected. This applies in particular to transparent particles, but also to particles that are the same color as the filter.

US 2015/0211976 A1 describes a method and a device for determining the load of dirt particles on workpieces. To do this, the particles of dirt are received in a fluid volume and the fluid containing the particles of dirt is filtered through a filter membrane. The particles of dirt deposited on the filter membrane are analyzed by means of a camera which acts as a microscope and allows for a magnified depiction of the particles of dirt on the filter membrane. The filter membrane is preferably coated and/or treated with chemical substances such as litmus. Discoloration/decoloration of the filter membrane makes it possible for conclusions to be drawn on the state (pH) of the cleaning liquid, for example.

US 2020/0256812 A1 likewise describes a method for analyzing an accumulation of particles on a filter membrane using a light microscope. In this case, the filter membrane is pulled taut.

### Technical Statement of the Problem

The object of the present invention is to provide a method which makes it possible to determine all the particles on the same membrane in parallel as completely as possible and can also be carried out in a simple and cost-effective manner.

Furthermore, the object of the present invention is to provide a device for analyzing particles on a membrane in an automated manner which makes it possible to determine all the particles on the same membrane in parallel as completely as possible.

Lastly, the object of the present invention is to provide a sample-preparation unit for the device.

### SUMMARY OF THE INVENTION

With regard to the method, the above-mentioned object is achieved according to the invention proceeding from a method of the type mentioned at the outset in that, for detecting contrasting particles, the transparency of the membrane to light radiation is increased before analyzing the particle accumulation.

Known membranes used for the particle analysis have the drawback that they have an inherent color which prevents all the particles on the same membrane from being determined in parallel. The inherent color of the membrane cannot, however, be readily changed without there being simultaneous implications for other important membrane properties, for example the mechanical or thermal stability, the porosity or the surface smoothness of the membrane.

The mechanical stability of the membrane both when dry and when moist is necessary both to be able to withstand the pressures arising during a filtration process and also to be able to be transported, for example to a drying oven, both when dry and when moist. The membrane surface must not be too smooth, so that the particles do not “float back and forth” on the surface during the extraction and analysis process. In addition, the porosity of the membrane should not be too low, so that the filtration process can proceed rapidly.

Changing said properties has implications for carrying out the analysis method and for the result of the analysis. For example, known transparent polycarbonate membranes only have low porosity and a very smooth surface. They can also only be handled with difficulty owing to their low thickness. This becomes apparent in particular when attempting to adhere a polycarbonate membrane to a glass surface. In practice, this results in a lack of adhesion homogeneity, which considerably impacts the subsequent optical analysis.

The concept underlying the present invention is therefore to increase the optical transparency of the filter membrane and to therefore change the inherent color of the membrane only before the method step of analyzing the particle accumulation, in particular to reduce the color of the membrane. At this point, the particle accumulation is already on the membrane. Preparatory method steps such as filtering a particle-containing flushing liquid, transferring a membrane to a glass underlayer, or fixing the particles to the membrane have already been carried out before the point of reducing the inherent color. The inherent color of the membrane is reduced according to the invention by the transparency of the membrane to light radiation being increased. Increasing the transparency to light, i.e. reducing the inherent color of the membrane, can be achieved by chemically and/or physically treating the membrane, for example. “Physically” means filling the pores with a liquid, for example, reducing the light refraction on membrane components, or “chemically” means removing or disintegrating the membrane.

Increasing the optical transparency by reducing the inherent color of the membrane only before the method step of analyzing the (optionally previously fixed) particle accumulation has several advantages:

Owing to the membrane not having an inherent color or having a reduced inherent color, any filter or background can be inserted into the beam path, for example. By using different filters or backgrounds, it is possible to inspect the same membrane under different conditions such that parallel determination of contrasting (i.e. light and dark) particles on the same membrane is possible.

A membrane having increased transparency is transparent to the light radiation in part or in full. By contrast with conventional, non-transparent membranes, this transparency also makes it possible to analyze particles found thereon by means of transmitted-light microscopy. Transmitted-light microscopy has significant advantages when detecting transparent particles.

Another advantage is that tried-and-tested membranes can be used in the method steps that prepare the optical analysis. This is simple and cost-effective, since existing knowledge can be used and these membranes are available at a reasonable price.

In a preferred configuration of the method according to the invention, increasing the transparency of the membrane to light radiation includes applying an ionic liquid to the membrane.

With regard to increasing the transparency of a membrane to light radiation, it has proven particularly successful for the ionic liquid to have a melting point below the standard temperature, preferably below 15° C.

Ionic liquids are suitable both for filling the pores in the membrane and for partially removing/disintegrating the membrane. Both of these effects result in a reduction in the light refraction on the membrane, in particular on fibers found therein, such as cellulose fibers. The ionic liquid can be applied to the membrane as a pure substance or as a mixture.

A particularly time-efficient and cost-effective method is obtained if applying the ionic liquid is accompanied by fixing the particle accumulation.

The ionic liquid is optionally suitable for removing the membrane, with a gel-like mass forming which contributes to partially embedding and fixing the particle accumulation. The particles are fixed and the transparency of the filter membrane to light is thus increased in the same method step here.

Particularly good results can be obtained with an ionic liquid if the membrane is a cellulose membrane, in particular a cellulose nitrate membrane.

The use of an ionic liquid also has the advantage that the membrane is optimized by applying the ionic liquid in respect of inspecting the same membrane both using an optical microscope and using an SEM-EDX system.

Owing to increased requirements, more precise material analysis is increasingly additionally being required, which is often carried out by means of SEM-EDX (SEM—scanning electron microscopy, EDX or EDS (energy-dispersive X-ray spectroscopy)). An SEM-EDX analysis provides comprehensive structural information as well as the ratios of the chemical elements. In this process, the atoms in the particle sample are excited by an electron beam having a specific energy level, such that said atoms emit X-ray radiation that is characteristic of the chemical element in question.

This can result in problems if the particles to be inspected are placed on an electrically non-conductive substrate, for example a filter membrane. This is because, due to the electrical charge of the substrate and the particles, there is both the risk that particles move or fly off in an uncontrolled manner and that electromagnetic fields deflect the electron beam. In addition, spontaneous discharges of the substrate and particles may occur, resulting in temporary signal flooding of the imaging detectors. This occurs in particular in SEM-EDX analyses, since, for this purpose, electrons have to be fired at the particles for a relatively long time and in a focused manner in order to obtain sufficiently high count rates for the SEM-EDX spectrum.

By making the membrane transparent to light radiation by means of an ionic liquid, owing to the intrinsic conductivity of the ionic liquid, the particle accumulation does not need to be coated with a conductive film before the SEM-EDX analysis; however, this requires glass covers not to be placed thereon when preparing the sample, since glass covers are not permeable to the electron beam in the SEM-EDX.

It has proven advantageous for the ionic liquid to contain ethyl ammonium nitrate (EAN) and/or 1-ethyl-3-methylimidazolium acetate (EMIM OAc).

Said ionic liquids are suitable for increasing the transparency of cellulose fibers and cellulose membranes, for example, and they have a comparatively low melting point. In the simplest case, the ionic liquid is applied to the substrate as a pure substance. It has, however, proven particularly successful for the ionic liquid to be applied in diluted form, preferably as an aqueous solution. The advantage of aqueous solutions is that they can penetrate and fill the pores in a hydrophilic membrane particularly effectively. This facilitates rapid, homogeneous distribution of the ionic liquid in the membrane and, associated therewith, a consistent and uniform increase in the optical transparency.

Advantageously, the ionic liquid diluted with water is applied to the filter membrane, wherein the dilution ratio (of ionic liquid to water) is in volume proportions in the range of from 1:1 to 7:1.

If the ionic liquid is diluted by more than 1:1, this impairs the transparency-increasing effect of the ionic liquid. With a dilution of less than 7:1, the effect of adding the water is lost. Alternatively or additionally, a not yet fully dried filter membrane is wetted with the ionic liquid. The residual moisture in the filter membrane may compensate for a low amount of water being added to the dilution, where necessary.

Increasing the transparency of the membrane to light radiation requires a certain reaction period of the ionic liquid on the membrane. Under standard conditions (SATP conditions), the reaction period is approximately 6 to 8 hours.

In a preferred modification to the method according to the invention, it is provided that, after applying the ionic liquid and before the analysis, the membrane comprising the particle accumulation is heated to a temperature in the range of from 50° C. to 85° C. for a time period of 1 to 4 hours and is then analyzed.

By means of the heating, the reaction period is shortened to 1 to 4 hours and the process is accelerated overall.

In another preferred configuration of the method according to the invention, it is provided that the analysis of the particle accumulation is carried out under a first and a second illumination condition, and the first illumination condition is generated by introducing a first background into the beam path.

The background is a metal or non-metal body, which is preferably non-transparent to light radiation and has an inherent color.

In the first instance, the above-described method configuration relates to incident-light microscopy, but it can also be used in transmitted-light microscopy.

In incident-light microscopy, the background is allocated to the lower face of the object. The illumination beam first impinges on the upper face of the object. Owing to the transparency to light of the membrane, which has been increased according to the invention, the illumination beam at least partially penetrates the object, such that it impinges on the background. The light of the illumination beam reflected by the object and the background is reflected into the imaging beam path, at least in part.

Two illumination conditions can be generated by introducing two backgrounds that are different from one another, but this can also be carried out using a single background. In the latter case, the analysis is carried out once with the background and once without.

By means of an analysis under two illumination conditions, the most complete possible detection of all particle types in a sample is made possible, irrespective of their contrast. In order to analyze light and/or transparent particles, a background should be inserted which has a good contrast with the light and/or transparent particles. Preferably, in order to analyze light and/or transparent particles, a grey or black background is used. In order to analyze dark particles, a light, preferably white, background is particularly suitable. It has proven advantageous for a non-metal background to be used for analyzing dark particles. This makes it possible to also differentiate between metal and non-metal particles.

Advantageously, the second illumination condition is generated by introducing a second background, which is different from the first background, into the beam path.

The second background may in particular be adapted to the expected particle spectrum. As a result, with a known pattern of contamination, the illumination conditions and thus the overall analysis can be optimized.

When taking the measurement using transmitted-light microscopy, no background is provided or the background has to be transparent, for example made of glass, which is inserted into the beam path between the light source and the object to be analyzed.

With regard to the device for analyzing an accumulation of particles on a membrane in an automated manner, the above-mentioned object is achieved according to the invention proceeding from a device of the type mentioned at the outset in that, by means of the sample-preparation unit, the transparency of the membrane to light radiation can be increased.

Known devices for analyzing an accumulation of particles on a membrane in an automated manner are also referred to as automated optical microscopes or as particle counting microscopes. They can be used for automated particle counting, particle measurement, and for categorization according to metallic sheen or textile fiber shape. Known membranes used for the particle analysis have the drawback that they have an inherent color which makes it difficult for all the particles on the same membrane to be determined in parallel. The inherent color of the membrane cannot be readily changed, however, since any change to the inherent color of the membrane would have implications for other important membrane parameters at the same time.

The concept underlying the present invention is to modify the sample-preparation unit of the device such that the inherent color of the membrane can be reduced thereby in an automated manner before the (optionally previously fixed) particle accumulation is examined under a microscope.

The inherent color of the membrane is reduced according to the invention by the transparency of the membrane to light radiation being increased. Increasing the transparency to light can be achieved by chemically and/or physically treating the membrane. Purely “physically” means filling the pores with a liquid, for example, which reduces the light refraction on membrane components, or “chemically” means removing or disintegrating the membrane.

Preferably, the sample-preparation unit comprises a pipetting unit, by means of which an ionic liquid can be applied to the membrane.

It has proven successful for the optical microscope to comprise a specimen stage, wherein a receptacle for introducing a background into the beam path in an automated manner is assigned to the specimen stage.

The receptacle makes it possible to introduce one or more backgrounds into the beam path in succession in an automated manner. Two illumination conditions can be generated by introducing two backgrounds that are different from one another.

By means of an analysis under two illumination conditions, the most complete possible detection of all particle types in a sample is made possible, irrespective of their contrast.

With regard to the sample-preparation unit, the above-mentioned object is achieved according to the invention proceeding from a sample-preparation unit of the type mentioned at the outset in that, by means of the sample-preparation unit, the transparency of the filter membrane to light radiation can be increased.

The sample-preparation unit is preferably designed for retrofitting to existing optical microscopes. Reference is made to what has been said above in relation to the device and the method.

It has proven successful for the sample-preparation unit to be configured for applying an ionic liquid to the filter membrane in an automated manner.

Ionic liquids are suitable both for filling the pores in the membrane and for partially removing/disintegrating the membrane. Both of these effects result in a reduction in the light refraction on the membrane, in particular on fibers found therein, such as cellulose fibers. The ionic liquid can be applied to the membrane as a pure substance or as a mixture.

The use of an ionic liquid also facilitates an inspection of the same membrane both using an optical microscope and using an SEM-EDX system.

### Definitions and Measurement Methods

A supplementary definition of particular terms from the above description is provided in the following. The definitions are part of the description of the invention. If there is any inconsistency between one of the following definitions and the rest of the description, what is stated in the description takes precedence.

### Transparency to Light

The transparency to light of the membrane at a measurement wavelength is determined by the transmission of the membrane or of a sample containing the membrane being measured at the measurement wavelength. Since the transparency to light depends on the viewing angle, it is determined in the direction of the surface normal of the membrane surface. To do this, a monochromatic light beam having the measurement wavelength and the intensity I₀ is directed onto the membrane perpendicularly to the surface spanned by the membrane and the intensity I₁ of the light beam is determined after emergence. The transparency to light of a membrane is increased if, before the method step increasing the transparency to light, the transmission of the membrane or of a sample containing the membrane is at least 50% lower, preferably at least 80% lower, than after said step.

### Ionic Liquid

An ionic liquid is a salt in liquid form. Ionic liquids are usually organic salts. Ionic liquids are substantially composed of positively and negatively charged ions.

### Background

Transparent bodies, for example glass, can be used as backgrounds for transmitted-light microscopy. Non-transparent, non-metal or metal bodies are suitable as backgrounds for incident-light microscopy.

### Standard Conditions

The temperature 298.15 K (25° C., 77° F.) and the absolute pressure 100 kPa (14.504 psi, 0.986 atm) are considered to be standard conditions (SATP conditions).

### EMBODIMENT

In the following, the invention will be explained in greater detail on the basis of an embodiment and drawings, in which, schematically:

FIG. 1 shows an accumulation of different particles on a filter membrane,

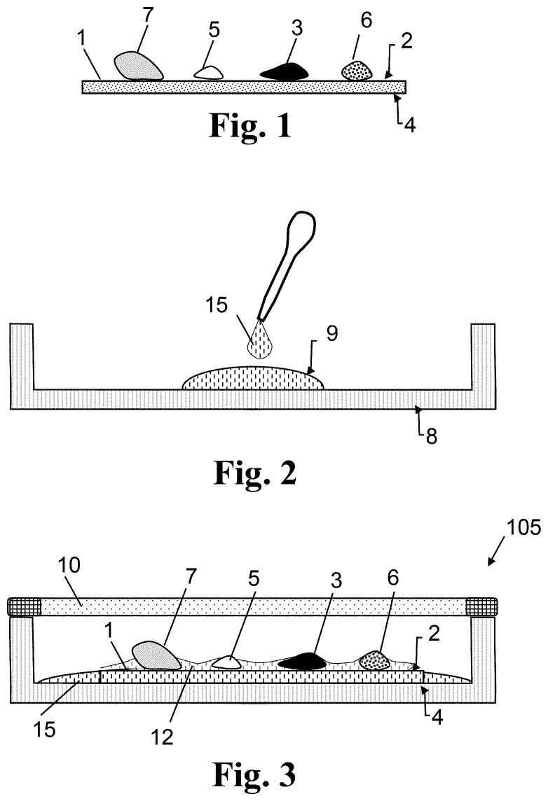

FIGS. 2 to 5 show method steps of a first method according to the invention for analyzing an accumulation of particles on a filter membrane,

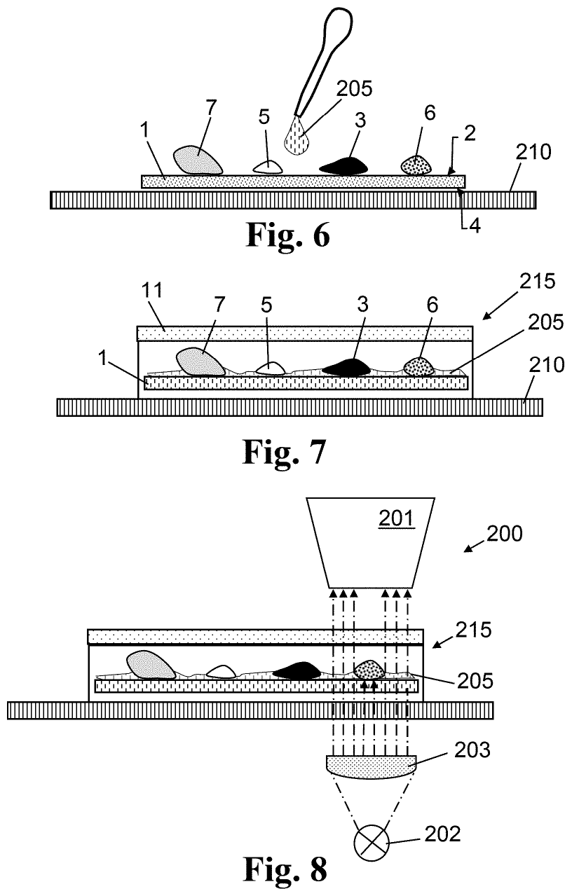

FIGS. 6 to 8 show method steps of a second method according to the invention for analyzing an accumulation of particles on a filter membrane, and

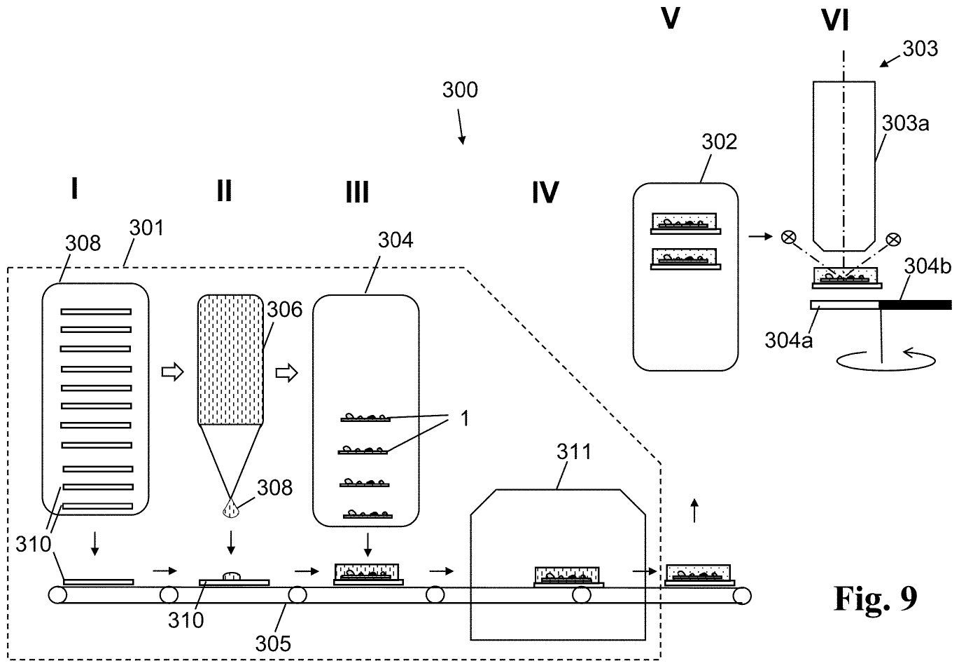

FIG. 9 shows an embodiment of a device according to the invention for analyzing an accumulation of particles on a filter membrane in an automated manner, comprising a sample-preparation unit according to the invention.

In order to determine the technical cleanliness of a component of a machine element, the component is cleaned with a flushing liquid. The collected flushing liquid contains the particles that have been cleaned off; it may contain both dark particles and light and/or transparent particles. The particle-containing flushing liquid is then filtered through a filter membrane made of cellulose, which retains the particles contained in the flushing liquid that have a particle size of greater than 2 μm. The particles contained in the flushing liquid are deposited on the upper face of the filter membrane.

It is clear that the method according to the invention is not limited to the above-described type of filter membrane, but instead other commercially available filter membranes can alternatively be used as a filter membrane.

FIG. 1 schematically shows the filter membrane 1 with an upper face 2 and a lower face 4. This view and the following schematic views are not true to scale, for reasons of presentation.

After filtering the particle-containing flushing liquid through the filter membrane 1, many accumulated particles are found on the upper face 2, of which only the particles 3, 5, 6, 7 are shown in the figure in a representative manner. The particles 3, 5, 6, 7 differ from one another in their color and in their transparency to light: particle 3 is a black, dark particle, particle 5 is a white, light particle, particle 6 is transparent to light radiation, and particle 7 is grey. The particles 3, 5, 6, 7 loosely adhere to the surface 2.

The methods described in the following are described on the basis of an analysis of the filter membrane 1 from FIG. 1.

FIGS. 2 to 5 schematically show a first approach in which the particle accumulation is analyzed using an incident-light microscope.

The filter membrane 1 with the particles 3, 5, 6, 7 thereon is first prepared for an analysis by means of light microscopy. To do this, in a first step, the particles 3, 5, 6, 7 are fixed to the filter membrane 1 and the transparency of the filter membrane 1 to light is increased at the same time.

FIG. 2 shows the provision of a glass underlayer in the form of a slide frame 8, to which 0.3 ml of a water-diluted solution 15 of ethyl ammonium nitrate (EAN) is applied, forming a droplet 9. The water-diluted EAN solution 15 was obtained by mixing EAN and water in a ratio of 3:1. Alternatively, EAN can also be applied to the glass underlayer without being diluted. Compared with undiluted EAN, the water-diluted EAN solution 15 has the advantage that it has a lower viscosity. This results in the water-diluted EAN solution 15 being better distributed over hydrophilic filter membranes.

The filter membrane 1 with the particles 3, 5, 6, 7 thereon is then placed onto the droplet 9 by its lower face 4. The water-diluted EAN solution 15 of the droplet 9 reaches the upper face 2 of the filter membrane 1 through the pores from the lower face 4 due to capillary force and, here, comes into contact with the surfaces of the particles 3, 5, 6, 7 which are in contact with the filter membrane 1. Owing to capillary force and surface tension, the water-diluted EAN solution 15 is drawn a little way upwards on particle surfaces. The water-diluted EAN solution 15 fulfils two purposes here. On one hand, it increases the transparency of the filter membrane 1 by filling the pores in the filter membrane 1 and simultaneously partially removing the structure of the filter membrane 1. This causes a reduction in the light refraction on the cellulose fibers of the filter membrane 1 and increases the transparency of the filter membrane to light radiation. On the other hand, together with the removed cellulose fibers, the water-diluted EAN solution 15 forms a mass 12 that fixes the particles 3, 5, 6, 7 to the filter membrane 1, as shown schematically in FIG. 3. The slide frame 8 can be closed by a removable, framed glass cover 10. The glass cover 10 is clipped on. As a result, the filter membrane 1 is protected against any further contamination. The protective glass of the glass cover 10 is selected such that it does not change the polarization state of the observation light and the optical analysis is not affected in dark-field illumination.

Increasing the transparency of the filter membrane 1 to light radiation under standard conditions takes several hours, however. The process of increasing the transparency to light can be accelerated by supplying heat. At a temperature of 70° C., approximately 2 hours are required for increasing the transparency of the filter membrane 1. Since the water-diluted EAN solution 7 remains in the filter membrane as a liquid, the transparency achieved is permanent. The transparency of the filter membrane to light that can be achieved by this process step is more than 5 times higher than in the original state and manifests in higher transparency, which is not only like frosted glass, but is also sufficient for the undisrupted imaging of the particles in the optical microscope, and specifically also with greater magnification and in transmitted light.

A filter membrane prepared as described above is referred to in the following as the sample 105; it can be analyzed both using an incident-light microscope and using a transmitted-light microscope.

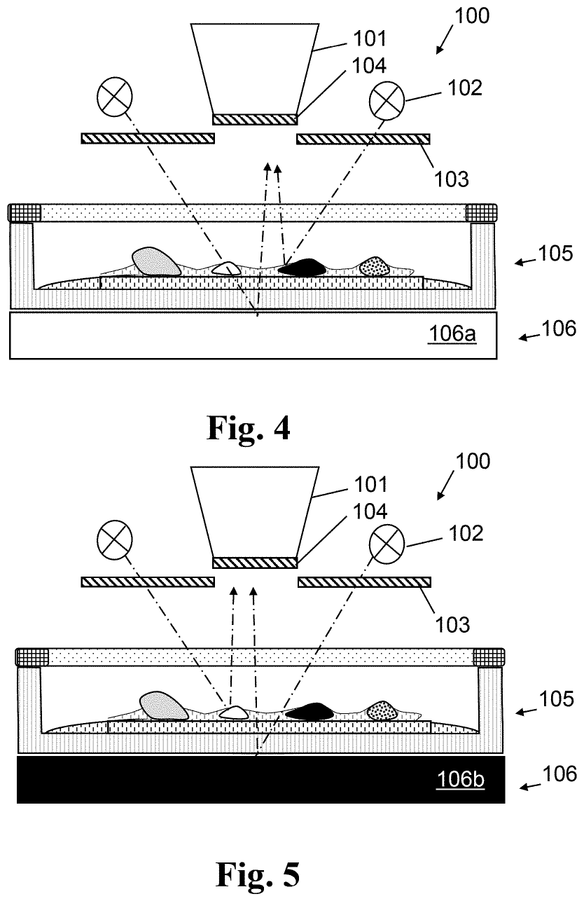

FIGS. 4 and 5 show the analysis of the sample 105 by means of an incident-light microscope 100. The incident-light microscope 100 comprises an optical imaging apparatus 101 for imaging the particle accumulation on the filter membrane 1, an illumination apparatus 102 arranged annularly around the optical imaging apparatus 101, as well as an optical polarizer 103, an optical analyzer 104 and a receptacle for a sample to be examined by a microscope that can be moved in all spatial directions. FIGS. 4 and 5 merely show, in a simplified manner, the sample 105 placed in the receptacle, and do not show the movable receptacle itself.

An insertion option (not shown) is arranged below the receptacle for a background 106. Instead, FIGS. 4 and 5 merely show the inserted background 106.

In FIG. 4, the background 106 is a light (white) background 106a. Bright-field illumination or dark-field illumination can be selected as the illumination type. In order to differentiate between metal and non-metal particles, the process is carried out using polarized light and dark-field illumination. Against this background, the grey particles 7 and the black particles 3 can be effectively detected. The white particles 5 and the transparent particles 6 are hardly detected at all, however.

In FIG. 5, the background 106 has been changed. Instead of the light background 106a, a dark, black background 106b is now allocated to the sample 105.

Alternatively, instead of the black background, a metal background can also be inserted, which likewise appears to be black under linearly polarized light and in a crossed polariser-analyser position. Against the black background 106b, the grey particles 7 and the white particles 5 can be effectively detected. The black particles 3 and the transparent particles 6 are hardly detected at all, however.

In this analysis, the size distribution is determined by counting and measuring the particles. In general, the qualitative distinction between metal and non-metal particles or a differentiation according to shape for detecting fibrous particles is also made.

As a result of the sample being inspected under two illumination conditions, i.e. with a white and a black background, the particles 3, 5, 7 can be effectively detected in any case. With regard to the transparent particles 6, it is difficult to predict whether these particles would be more likely to be visible against a light or dark background. By means of the two illumination conditions, the probability of detecting the transparent particle 6 is increased in any case and therefore the detectability of transparent particles is improved overall.

FIGS. 6 to 8 schematically show another approach, in which the filter membrane 1 is placed onto a specimen carrier 210 rather than onto a slide frame 8 and water-diluted ethyl ammonium nitrate (EAN) 205 is applied to the upper face 2 of the filter membrane 1. The filter membrane 1 is then covered with a cover slip 11 and is analyzed using a transmitted-light microscope 200.

FIG. 6 shows the method step of dropping diluted ethyl ammonium nitrate (EAN) onto the filter membrane 1. In order to prevent particles 3, 5, 6, 7 from being covered with ionic liquid, said ethyl ammonium nitrate is preferably dropped on at the edge or at another point on the upper face 2 of the filter membrane that does not contain any particles 3, 5, 6, 7 or is not required for the subsequent analysis. The ethyl ammonium nitrate (EAN) 205 is dropped on until it has been distributed far enough that the entire filter membrane is wetted.

As shown in FIG. 7, the filter membrane 1 is then covered with a cover slip 11 and is stored at 70° C. for 2 hours in order to increase the transparency of the filter membrane 1 to light radiation. The thus prepared filter membrane 1 is referred to in the following as the sample 215.

The sample 215 is then analyzed in an optical transmitted-light microscope 200. FIG. 8 shows the transmitted-light microscope 200 using which the sample 215 is analyzed. The transmitted-light microscope 200 has an optical imaging apparatus 201 for imaging the particle accumulation, an LED lamp 202 comprising a diffuser 203, as well as a receptacle for the sample 215 to be examined by a microscope that can be moved in all spatial directions. FIG. 8 merely shows, in a simplified manner, the sample 215 placed in the receptacle, and does not show the movable receptacle itself.

In the transmitted light, all the particles (except for the transparent particles that are lying flat) cast shadows, since the light is refracted out of the beam path. Using this method, although a distinction between metal and non-metal particles is not possible, it is advantageous for the analysis of particle accumulations containing transparent particles (e.g. glass beads from blasting material), since, for example, glass balls cast clear shadow patterns owing to the refractive behavior in transmitted light, and would not be effectively detected in incident light.

FIG. 9 shows a device 300 for analyzing an accumulation of particles on a filter membrane in an automated manner. The device 300 comprises a sample-preparation unit 301, a microscope sampler 302, and an optics unit 303 comprising an incident-light microscope. The device 300 is configured such that the sample preparation and analysis of a filter membrane 1 with a particle accumulation thereon is possible in a fully automated manner by means of said device.

The device 300 can be divided into six functional sections. In section I, there is a storage container 308 for glass underlayers 310. To simplify the description, the device is described in the following on the basis of the preparation and analysis of a single sample. First, the glass underlayer 310 is supplied to a sample-preparation unit 306 in section II from the storage container in an automated manner using a transport apparatus 305. In this section, 0.3 ml of an ethyl ammonium-nitrate and water mixture 308 (mixing ratio 3:1) is dropped onto the glass underlayer 310. The transport apparatus transports the glass underlayer with the mixture dropped thereon into section III. In this section, a sample, i.e. a filter membrane, is applied to the glass underlayer 310 with the mixture dropped thereon, on the upper face of which filter membrane a particle accumulation to be analyzed is located. This also takes place in an automated manner by means of a sampler 304, to which samples can be supplied in an automated manner or manually. The samples are kept in the sampler 304 and are stored under standard conditions until their analysis can be started. When the analysis is started, the sample is applied to the glass underlayer 310 with the mixture dropped thereon, such that the ethyl ammonium-nitrate and water mixture on the glass underlayer 310 reaches the upper face 2 through the pores due to capillary force and, here, comes into contact with the surfaces of the particles which are in contact with the filter membrane 1. The sample is also covered with a cover slip. The sample is then supplied to section IV, in which the sample is heated for 120 minutes to 70° C. using a conveyor furnace 311. Lastly, the sample is supplied by the transport apparatus 305 to the microscope sampler 302, where the sample is stored until it is analyzed using a microscope. The microscope sampler 302 provides the sample for microscopic analysis using the incident-light microscope 303a in an automated manner.

The incident-light microscope 303a has a visual field of between 0.1 mm² and 100 mm². It is equipped with a digital camera, which is connected to a computer (not shown). The computer serves to evaluate and analyze, in an automated manner, images transmitted from the digital camera to the computer. The incident-light microscope 303a is equipped such that it makes it possible to switch between a light background 304a and a dark background 304b in an automated manner.

1. Method for analyzing an accumulation of particles on a membrane using an optical microscope, wherein, for detecting contrasting (light and dark) particles, the transparency of the membrane to light radiation is increased before analyzing the particle accumulation.

2. Method according to claim 1, wherein increasing the transparency of the membrane to light radiation includes applying an ionic liquid to the membrane.

3. Method according to claim 2, wherein applying the ionic liquid is accompanied by fixing the particle accumulation to the membrane.

4. Method according to claim 2, wherein the ionic liquid contains ethyl ammonium nitrate (EAN) and/or 1-ethyl-3-methylimidazolium acetate (EMIM OAc).

5. Method according to claim 1, wherein the ionic liquid diluted with water is applied to the membrane, wherein the dilution ratio (of ionic liquid to water) is in volume proportions in the range of from 1:1 to 7:1.

6. Method according to claim 1, wherein after applying the ionic liquid and before the analysis according to method step (b), the membrane comprising the particle accumulation is heated to a temperature in the range of from 50° C. to 85° C. for 1 to 4 hours and is then analyzed according to method step (b).

7. Method according to claim 1, wherein the analysis of the particle accumulation is carried out under a first and a second illumination condition, and the first illumination condition is generated by introducing a first background into the beam path.

8. Method according to claim 7, wherein the second illumination condition is generated by introducing a second background, which is different from the first background, into the beam path.

9. Device for analyzing an accumulation of particles on a membrane in an automated manner, comprising:
(a) a sample-preparation unit for preparing the particle accumulation on the membrane in an automated manner, and
(b) an optics unit comprising an optical microscope for analyzing the particle accumulation in an automated manner,
wherein, by means of the sample-preparation unit, the transparency of the membrane to light radiation can be increased.

10. Device according to claim 9, wherein the optical microscope comprises a specimen stage, wherein a receptacle for introducing a background into the beam path in an automated manner is assigned to the specimen stage.

11. Sample-preparation unit for a device for analyzing an accumulation of particles on a membrane in an automated manner, wherein the sample-preparation unit is configured for preparing the particle accumulation on the membrane in an automated manner, wherein, by means of the sample-preparation unit, the transparency of the membrane to light radiation can be increased.

12. Sample-preparation unit according to claim 11, wherein the sample-preparation unit is configured for applying an ionic liquid to the membrane in an automated manner.
